(19) United States
(12) Patent Application Publication
(10) Pub. No.: US 2005/0135650 A1
(43) Pub. Date: Jun. 23, 2005

(54) Earplug training device and earplug dispensing mechanism having the same

(76) Inventor: Elliott H. Berger, Indianapolis, IN (US)

Correspondence Address: CANTOR COLBURN LLP, 55 Griffin Road South, Bloomfield, CT, 06002, US

(21) Appl. No.: 10/740,180

(22) Filed: Dec. 17, 2003

(51) Int. Cl. H04R 1/02; H04R 1/20; H04R 25/00

(52) U.S. Cl. 381/382; 381/337

(57) ABSTRACT

An earplug training device is provided, including a thin sheet portion having a front surface and an opposing rear surface, and a substantially circular hole formed in the thin sheet portion, said hole traversing through the sheet portion from the front surface to the rear surface, where the substantially circular hole enables a user to practice roll down preparation of the earplug. An earplug dispenser including an earplug training device and a method of dispensing earplugs, are further provided.

### TECHNICAL FIELD OF INVENTION

The invention generally concerns hearing protection devices and, more particularly, concerns a device which provides instruction and/or training regarding earplugs, an earplug dispensing mechanism incorporating the earplug training device, and a method of dispensing earplugs.

### DESCRIPTION OF RELATED ART

The need for individual hearing protection in industrial and other occupational and recreational settings is well established. The prior art is replete with hearing protection devices, including earplugs, earmuffs, semi-insert devices, full-head helmets, etc. Earplugs are often preferred for the sound attenuating and comfort properties provided thereby.

Compressible, slow-recovery foam earplugs, as those disclosed in U.S. Pat. No. 6,105,715 to Knauer, herein incorporated by reference in its entirety, are widely used to provide hearing protection. Such foam earplugs, commonly known as “roll-down” type earplugs, are typically composed of a homogenous slow recovery polyvinyl chloride (PVC) or polyurethane (PU) material and include a substantially circular cross-section which is larger than a cross-section of the average earcanal.

Referring to FIGS. 1-6, to properly insert a roll-down earplug 2 in an earcanal 4, the plug 2 is first compressed by slowly rolling the plug 2 between the thumb 6 and opposing fingers 8 of one or both hands 10. This rolling compresses the earplug 2 and reduces its original diameter to a new diameter which is less than that of the earcanal 4. While the earplug 2 is still compressed, a first end thereof is inserted into the opening of the earcanal 4 and the earplug 8 is passed well into the canal 4. To aid deep insertion, the outer portion, or pinna 12, of the ear 14 may be pulled upward and outward from the head to straighten and better expose the earcanal 4. This technique is particularly shown in FIG. 6. Once fully inserted, the pinna 12 is released and the earplug 2 is allowed to expand within the earcanal 4 to fully occlude the earcanal 4 and thus obstruct the passage of sound therethrough.

The relationship between proper earcanal fit of roll-down earplugs and their maximum performance as sound attenuators, is well known. See, e.g., Laboratory Attenuation of Earmuffs and Earplugs Both Singly and in Combination, Am. Ind. Hyg. J. 44(5), 321-329 (1983). As mentioned, roll-down earplugs attenuate sound by causing an occlusion deep within the earcanal, thus obstructing the passage of sound therethrough. However, when the earplug is improperly fitted within the earcanal, full occlusion is not achieved. Attenuation is reduced because of the reduced surface area of contact of the plug with the earcanal walls. Furthermore, if the plug is improperly rolled and compressed, creases can occur on the surface of the plug which act as sound channels and permit the leakage of sound into the canal, further degrading protection.

Attempts have been made at ensuring proper fit of roll-down earplugs. Regulatory agencies such as the Occupational Safety and Heath Administration (OSHA) and the Mining Safety and Health Administration (MSHA) have promulgated doctrine requiring employers of employees exposed certain workplace noise to develop hearing conservation programs and regularly train such employees on proper use, handling, and fitting of hearing protection devices.

Accordingly, many of these employers implement workplace training sessions concerning proper insertion of roll-down foam earplugs and provide literature accentuating the same. Such training sessions may be provided before, during, or after working hours, formally in a classroom setting, or informally on the workplace floor. Such instructional literature may be provided in common workplace areas, for example at tool cribs, or in cafeterias or other training spaces, or disseminated to individual employees.

However, earplug insertion training sessions are only effective if the instructor is competent, the sessions are attended, and the attendees pay attention to and comprehend the particular instructions. In any event, training sessions are often offered only sporadically and fail to serve as repetitive training mechanisms.

Earplug insertion literature which is posted in common workplace areas may easily go unnoticed while individually disseminated literature may quickly be discarded and, moreover, even if such literature is read by the relevant employees, it may not be understood.

Further, these instruction sessions and instructional literature may also include information of additional hearing protection devices not of concern to earplug wearing employees. Thus, proper earplug insertion instruction may be lost amidst verbose explanation germane to earmuffs, semi-inserts, etc. Additionally, the instructional and literature based techniques are expensive and detract from working time thus degrading overall efficiency without ensuring proper absorption and retention of the proper earplug insertion procedures.

As mentioned, performance and comfort of roll-down foam earplugs can be dramatically improved by a full and effective insertion. However, few people grasp the details of roll-down and insertion techniques that will lead to maximal effectiveness. Two separate skills are required, namely rolling and preparing the plug for insertion and then inserting it into the earcanal, a hole on the side of the head that can never been seen. Thus the ability to practice rolling, independent of insertion is a valuable learning aid.

A final aspect to consider is Applicant's experience in 30 years of selling foam earplugs which indicates that few can conceive of how tightly and fully compressed a plug must be for optimal insertion. Yet, once they learn the process, an enlightening or “a—ha” experience occurs, like learning to ride a two-wheel bicycle, and thereafter the user can learn through practice to repeat the simple process.

Accordingly, a readily available, effective, and efficient device for training users in preferred use of compressible foam earplugs, and particularly for training users in insertion preparation of foam earplugs, is desired.

### BRIEF SUMMARY OF THE INVENTION

The invention provides an earplug training device, including a thin sheet portion having a front surface and an opposing rear surface, and a substantially circular hole formed in the thin sheet portion, the hole traversing through the sheet portion from the front surface to the rear surface, where the substantially circular hole enables a user to practice roll down preparation of the earplug.

In another embodiment of the invention, an earplug training device includes a thin sheet portion, a manually interactive portion disposed on the thin sheet portion, where the manually interactive portion provides a user with hands on instruction and/or training in a use of the earplug.

An earplug dispenser is further provided, the dispenser including a container for storing and dispensing earplugs, and a substantially circular hole formed in an outer surface of the container; wherein the substantially circular hole enables a user to practice roll down preparation of an earplug.

In another embodiment of the invention, an earplug dispenser, includes a container for storing and dispensing earplugs, a manually interactive portion disposed at an outer surface of the container; wherein the manually interactive portion provides a user with hands-on instruction and/or training in a use of the earplugs.

Also, a method of dispensing earplugs is disclosed, including providing the earplugs at an interior of a container, allowing a user to access the earplugs at the interior, and providing the user with hands-on instruction and/or training in a use of the earplugs at a manually interactive portion disposed at the container.

### BRIEF DESCRIPTION OF THE DRAWINGS

Referring now to the drawings wherein like elements are numbered alike in the several FIGURES:

FIGS. 1-4 are perspective views of a user preparing an earplug for earcanal insertion;

FIG. 5 is a view of a user inserting an earplug in an earcanal, the ear and earcanal are shown in section;

FIG. 6 is another perspective view of a user inserting an earplug in an earcanal;

FIG. 7 is a perspective view of an earplug training device;

FIG. 8 is a perspective view of an earplug;

FIG. 9 is a perspective view of the earplug of FIG. 8 in a rolled-down, compressed state;

FIG. 10 is a perspective view of another embodiment of the earplug training device;

FIG. 11 is a perspective view of another embodiment of the earplug training device;

FIG. 12 is a perspective view of an earplug dispenser;

FIG. 13 is an enlarged side elevational view thereof;

FIG. 14 is an enlarged perspective view of an aperture thereof;

FIG. 15 is an enlarged perspective view of the aperture of FIG. 14 in another embodiment of the invention;

FIG. 16 is an enlarged side elevational view of another embodiment of the earplug dispenser;

FIG. 17 is an enlarged side elevational view thereof in another embodiment of the invention;

FIG. 18 is a perspective view of an earplug dispenser in another embodiment of the invention; and

FIG. 19 is a perspective view of an earplug dispenser in another embodiment of the invention.

### DETAILED DESCRIPTION OF THE INVENTION

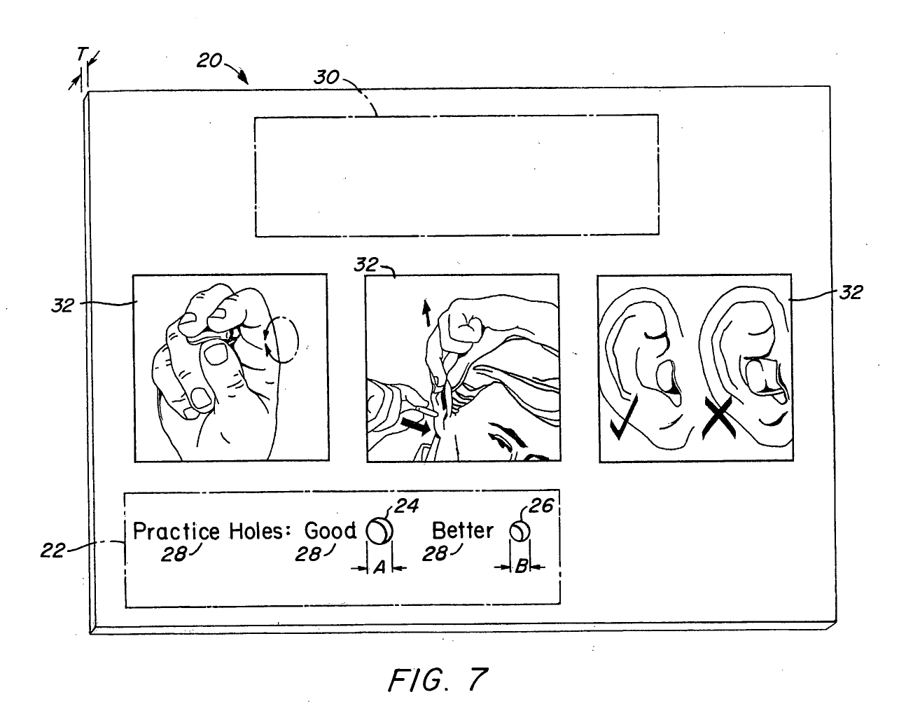

FIG. 7 shows an earplug training device 20 in an exemplary embodiment of the invention. The training device 20 includes a manually interactive portion 22 on a front face of the training device 20.

The manually interactive portion 22 is intended herein and throughout the present description to indicate a portion of the training device 20 where a user may partake in manual, hands-on training and/or practicing concerning use of earplugs, and particularly concerning preferred earplug pre-insertion preparation techniques, for example earplug roll down preparation as described herein, and/or earcanal insertion techniques. That is, the manually interactive portion 22 serves as an interface which provides the user with a tactile, manual, and/or tangible means of practicing proper earplug pre-insertion preparation and/or assisting in actual earplug insertion.

In the present embodiment, the manually interactive portion 22 comprises a first aperture 24 and an adjacent second aperture 26. The apertures 24 and 26 are substantially circular holes having diameters A and B, respectively. The diameter A is approximately 0.26 inches and the diameter B is approximately 0.20 inches. The apertures 24 and 26 traverse through a thickness T of the training device 20. That is, the apertures 24 and 26 open at opposite front and rear sides of the training device 20. The manually interactive portion 22 further includes indicia 28 disposed proximate to the apertures 24, 26.

The training device 20 as shown embodied in FIG. 7 also includes a text portion 30 and illustrations 32 disposed adjacent the manually interactive portion 22.

The thickness dimension T of the earplug training device 20 is relatively small, for example, 0.05 inches to 0.25 inches. In a preferred embodiment, the training device is essentially a thin sheet composed of any sufficient material including paper, corrugated board, a plastic, a metal, compositions thereof, etc.

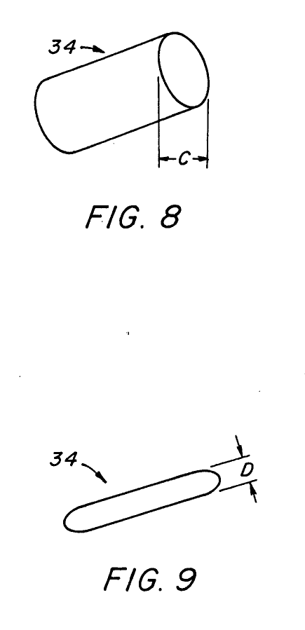

The earplug training device 20, in essence, provides a tool for training a user concerning a preferred technique for preparing an earplug 34, as shown in FIG. 8, for insertion into the earcanal. The earplug 34 comprises a homogenous slow-recovery foam “roll-down” type earplug with a cross-sectional diameter C. The earplug 34 is composed of any suitable foam material including, but not limited to, polyvinyl chloride (PVC), polyurethane (PU), etc.

In use, generally, the earplug 34 is first compressed, preferably by rolling about a longitudinal axis thereof, such that a reduced diameter D is achieved. See, FIG. 9. Then, with one hand pulling upward and outward on a pinna portion of the ear, the compressed reduced diameter earplug 34 is inserted deeply into the earcanal, and allowed therein to expand, thus occluding the canal. A proper crease-fee and very tight compression of the earplug 34 is essential to attain the reduced diameter D and thus facilitate proper insertion.

The earplug training device 20 allows a user to practice attaining the reduced diameter D of the earplug 34 desired for preferred insertion of the earplug 34 into the earcanal. Namely, the first aperture 24 with diameter A (≈0.26″) is equal to or slightly smaller than the desired diameter D. The second aperture 26 with diameter B (≈0.20″) is even smaller still than the desired compressed earplug diameter D and smaller than the diameter A of the aperture 24. Accordingly, a user may practice preparing the earplug 34 for earcanal insertion by first rolling down or otherwise compressing the earplug 34 and then attempting to insert the compressed earplug 34 into the first aperture 24. If the earplug 34 is easily received within aperture 24, then it is apparent that at least the preferred compressed diameter D has been achieved. The user may then, in addition to or in the alternative, attempt to insert the compressed earplug 34 into the second aperture 26. If the compressed earplug 34 is readily received within the second aperture 26, then it is apparent that the earplug 34 is compressed even smaller than the desired diameter D and, thus, the earplug will be even easier to insert properly.

The indicia 28 disposed on the earplug training device 20 proximate the apertures 24 and 26 is designed to assist the user in interpreting the results of their attempts at inserting the compressed earplug 34 into the apertures 24 and 26. In on exemplary embodiment, the indicia 28 adjacent the first aperture 24 reads, “Good”, and the indicia 28 proximate the second aperture 26 reads, “Better”. Thus, when insertion into the first aperture 24 is achieved, the user is informed that the compressed earplug is satisfactory or good. Further, upon insertion into the second aperture, the user is appraised that the compressed earplug is even more preferred or better.

The text portion 30 and the illustrations 32 disposed adjacent the manually interactive portion 22 are designed to support the training and instruction provided by the manually interactive portion 22. Specifically, the text 30 and illustrations 32 comprise instructions, explanations, and other information concerning: preparing the earplug 34 for earcanal insertion; actually inserting the earplug 34 into the earcanal; and/or using the manually interactive portion 22 and interpreting the results thereof.

The manually interactive portion 22 has thus far been described as providing a means for a user to practice preparing the earplug 34 for insertion into the earcanal. Additionally, the manually interactive portion 22 may be utilized by the user in actually inserting the earplug 34 into the earcanal. That is, to insert the earplug 34, the user may engage the earplug training device 20 and first consult with the text portion 30 and accompanying illustrations 32 which instruct the user in the preferred insertion procedure. Following the instructions and explanations of the text 30 and illustrations 32, the user rolls-down and compresses the earplug 34 and attempts insertion into apertures 24 and/or 26. If insertion into one of the apertures 24, 26 is achieved, then the user inserts the compressed earplug 34 into the earcanal. If, on the other hand, aperture insertion is not achieved, the user knows that the earplug 34 is not compressed properly and earcanal insertion not attempted. Instead, the earplug is re-rolled and compressed until aperture insertion, and the desired diameter D, is achieved. Then, earcanal insertion is performed. Once the desired diameter D is indeed achieved, it is essential that the user promptly inserts the earplug to ensure that the plug, in its preferred compressed state, enters the earcanal. Thus, the manually interactive portion 22 advises the user to insert the properly compressed earplug in a timely manner and to maintain the diameter D of the earplug while transferring the earplug from the manually interactive portion 22 to the earcanal.

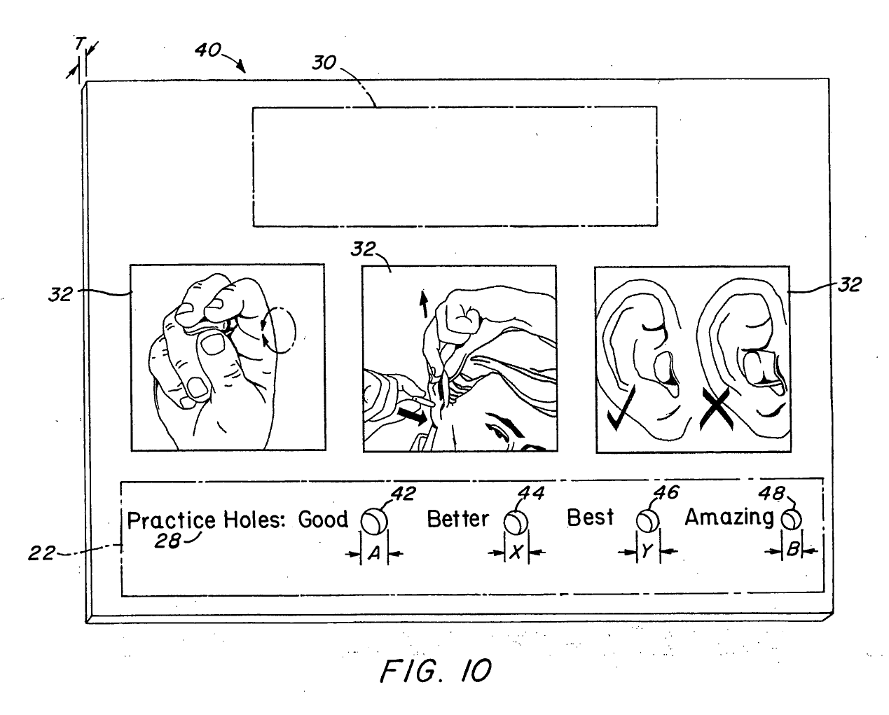

FIG. 10 shows an earplug training device 40 in another embodiment of the invention. Please note, like elements and features of the various embodiments of the invention are designated herein and throughout by consistent reference numerals.

The device 40 includes the manually interactive portion 22, the text portion 30, and the illustrations 32. Here, the manually interactive portion 22 includes first through fourth apertures 42, 44, 46, and 48, respectively, of serially decreasing diameter. The first aperture 42 includes the diameter A discussed previously as being approximately 0.26 inches. The fourth aperture 48 includes the diameter B discussed previously as being approximately 0.20 inches. The intervening second and third apertures have diameters X and Y of approximately 0.24 inches and approximately 0.22 inches, respectively. The manually interactive portion 22 further includes the indicia 28 which comprises the following words, or the like, disposed adjacent each of the apertures 42, 44, 46, and 48, respectively: “Good”; “Better”; “Best”; and “Amazing”.

Here again, the earplug training device 40 is preferably utilized by a user to practice preparing the earplug 34 for earcanal insertion. That is, the user first compresses the earplug 34 by rolling-down the same. Then, the user attempts to insert the compressed earplug into one of the apertures 42, 44, 46, or 48. If aperture insertion is successful, the user knows that the diameter of the compressed earplug is sufficient for facilitating preferred earcanal insertion. Moreover, the user is advised by the indicia 28 as to the degree of sufficiency of the rolled down earplug 34. Particularly, the user is appraised that insertion of the compressed earplug 34 into the aperture 42 is good or satisfactory, insertion into aperture 44 is more preferred, insertion into aperture 46 is even more preferred, and so on.

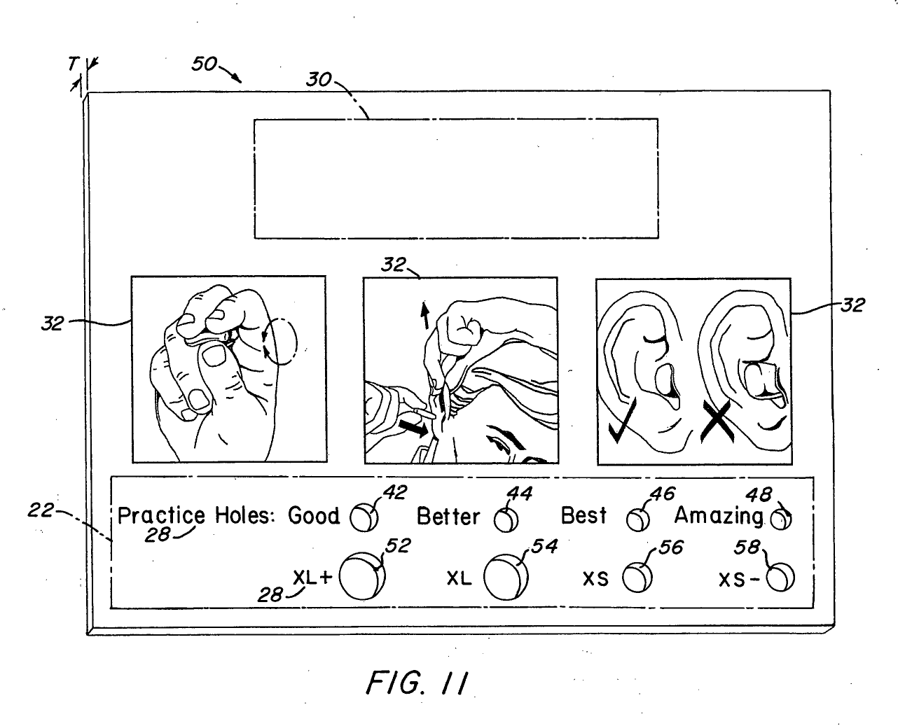

FIG. 11 shows an earplug training device 50 in another embodiment of the invention. The device 50 comprises the manually interactive portion 22, the text portion 30, and the illustrations 32. The manually interactive portion 22 includes the apertures 42, 44, 46, and 48 discussed above and additional apertures 52, 54, 56, and 58 disposed proximate apertures 42, 44, 46, and 48. The apertures 52, 54, 56, and 58 are substantially circular holes formed through the device 20 and include serially decreasing diameters such as, for example, approximately 0.28, 0.30, 0.45, and 0.47 inches, respectively.

The apertures 52, 54, 56, and 58 are intended to represent a range of earcanal diameter sizes of an average population. Particularly, the largest aperture 52 corresponds to the largest earcanal diameter and the smallest of the apertures 58 represents the smallest earcanal, on average. These largest and smallest apertures 52 and 58 are indicated accordingly by indicia 28, such as, for example, “XL+” and “XS−”, respectively. The remaining apertures 54 and 56 represent the second to largest and the second to smallest earcanal, on average. These apertures 54 and 56 are labeled with appropriate indicia 28 such as, “XL” and “XS”.

The earplug training device 50 is preferably utilized by a user, similar to the devices described above, to practice preparing the earplug 34 for earcanal insertion. Additionally, the training device 50 allows the user to determine the capability of a chosen earplug with respect to the various earcanal sizes represented by apertures 52, 54, 56, 58.

That is, the user may engage the device 50 to practice rolling-down and compressing the earplug 34, as is described in detail above. Additionally or alternatively, the user may insert the compressed earplug 34 into one of the sizing apertures 52, 54, 56, and 58. If such earplug 34 is successfully inserted, then it is apparent to the user that the earplug 34 is of sufficient size to facilitate insertion into the earcanal size designated by the particular aperture 52, 54, 56, or 58. Further, the user may then allow the inserted earplug 34 to expand within and fill the particular aperture 52, 54, 56, or 58. If, in its fully expanded state, the earplug 34 still fits tightly within the aperture, the user may conclude that the earplug 34 is of sufficient size to occlude the indicated earcanal size. If, to the contrary, the earplug 34 is not capable of insertion into the particular aperture 52, 54, 56, or 58, or if the earplug 34 may be inserted but does not result in a tight fit in the aperture after expansion, then the user is advised that the earplug is not suited for the specified earcanal size.

While several embodiments of the earplug training device of the invention have been shown and described herein, clearly, other embodiments, variations, and combination thereof are contemplated. For example, a training device of the invention may include any number of the apertures 24, 26, 42, 44, 46, 48, 52, 54, 56, and 58 and such apertures may be of any size or shape suitable for a particular application. The device of the invention may further include additional apertures of various sizes and shape, as desired.

As mentioned above, the thickness T of the earplug training devices 20, 40, and 50 is relatively small, for example between 0.05 inches and 0.25 inches. In one embodiment, the devices 20, 40, and 50 comprise a piece of paper or a thin piece of cardboard. The devices 20, 40, and 50 may be sized as desired, for example including a height H of 2.0 inches and a width W of 3.50 inches such that the device 20, 40, 50 approximates the size of a standard business card. Such device 20, 40, 50 may be readily distributed, carried, and accessed as necessary. Alternatively, H may be 8.5 inches and W may be 11 inches such that the device 20, 40, 50 approximates a standard sheet of paper. Still further, the device 20, 40, 50 may be smaller or larger as desired.

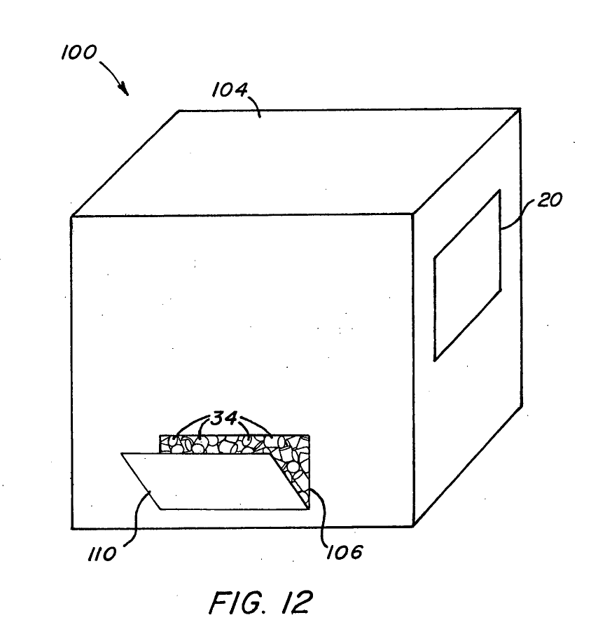

In a particularly preferred embodiment of the invention, FIG. 12 shows an earplug dispenser 100 having the earplug training device 20 integrated on a side thereof. The dispenser 100 includes a body 104 having an access portion 106 at an outer surface of the body 104. The access portion 106 allows a user to access and obtain a plurality of the earplugs 34 disposed and contained within the body 104 of the dispenser 100.

The body 104 of the dispenser 100 may be rectilinear in shape and may be composed of corrugated board, plastic, etc. The body 104 is designed to be disposed in a free-standing manner, for example on a tabletop, or, alternatively, the body 104 may be designed to be mounted on a wall. In the latter case, the body 104 may include mounting hardware and/or fittings to facilitate said mounting.

The access portion 106 of the body 104 comprises a hole formed therethrough creating an access way to an interior of the body 104. The access portion 106 is preferably disposed on the outer surface of the body 104 in a visible and readily accessible location, for example on a front face of the body 104 as shown in FIG. 12. Access to the interior of the body 104 via the access portion 106 may be selectively limited by a door 110 pivotally attached to the body 104 proximate to the access portion 106. In one embodiment, the door 110 is attached to the outer surface of the body portion 104 by a living hinge at a bottom of the access portion 106 and is manually pivotal between an open position in which the earplugs 34 at an interior of body 104 are accessible and a closed position where access to the interior is prohibited.

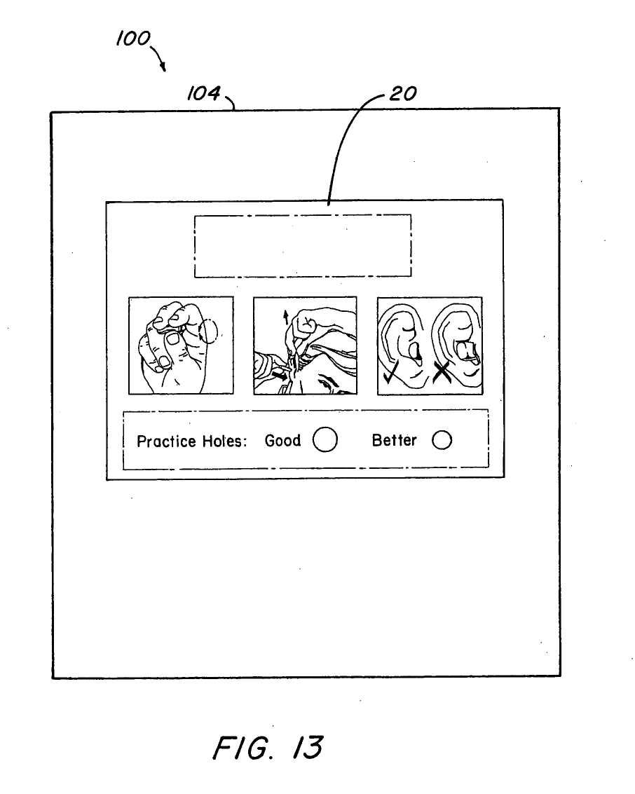

The earplug training device 20 is disposed on the outer surface of the body 104 in a visibly distinct and readily accessible location, for example, on a side of the body 104 as shown in FIGS. 12 and 13. The device 20 may be affixed to the side of the dispenser 100 in some manner, for example by a bonding agent such as glue, or, more preferably, the device 20 may be formed integrally with the body 104.

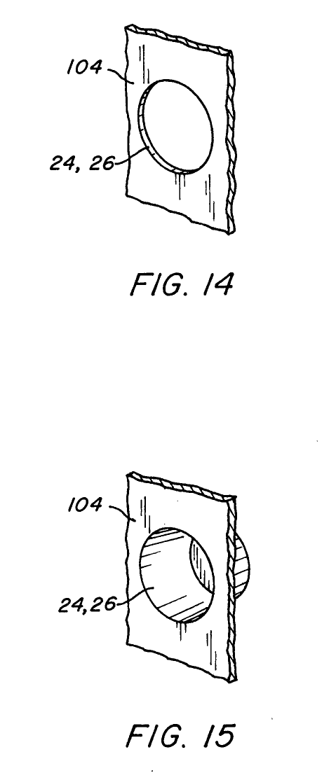

As discussed above, the apertures 24 and 26 of the training device 20 comprise substantially circular holes having various diameters A and B, respectively. In one embodiment, as shown in FIG. 14, the apertures 24 and 26 extend through the side of the body 104 and thus open to the interior of the body 104. Here, the apertures 24, 26 are simply die cut into the material composing the body 104. In another embodiment, as shown in FIG. 15, aperture 24, 26 comprises a three-dimensional depression or hole formed into the outer surface of the body 104 of the dispenser 100. Here, the hole extends a predetermined distance into the body 104 and then terminates therein. The aperture 24, 26 in this embodiment may be formed integrally with the outer surface of the body 104 or may be a separate piece fixed to the body 104. In this latter configuration, the aperture 24, 26 may comprise a plastic or rubber unit, perhaps resembling a thimble, which is set into a hole pre-formed in the outer surface of the body 104 and then bonded to the outer surface or inner surface with a bonding agent, such as a glue. In the embodiment of FIG. 15, the depth of the aperture 24, 26 may be sized to represent a desired depth of earplug insertion into an earcanal of a user.

The earplug dispenser 100 is used to dispense the foam roll-down earplugs 34 contained with the body 104 of the dispenser 100 to a user. Additionally, the dispenser 100, via the earplug training device 20, provides a manually interactive tool for training a user concerning use of the dispensed earplugs 34.

That is, the user first approaches the dispenser 100 and obtains the earplugs 34 by placing the door 110 in the open position and then reaching through the access portion 106 into the interior of the body 104. One or more of the earplugs 34 are manually grasped and then withdrawn from the body 104.

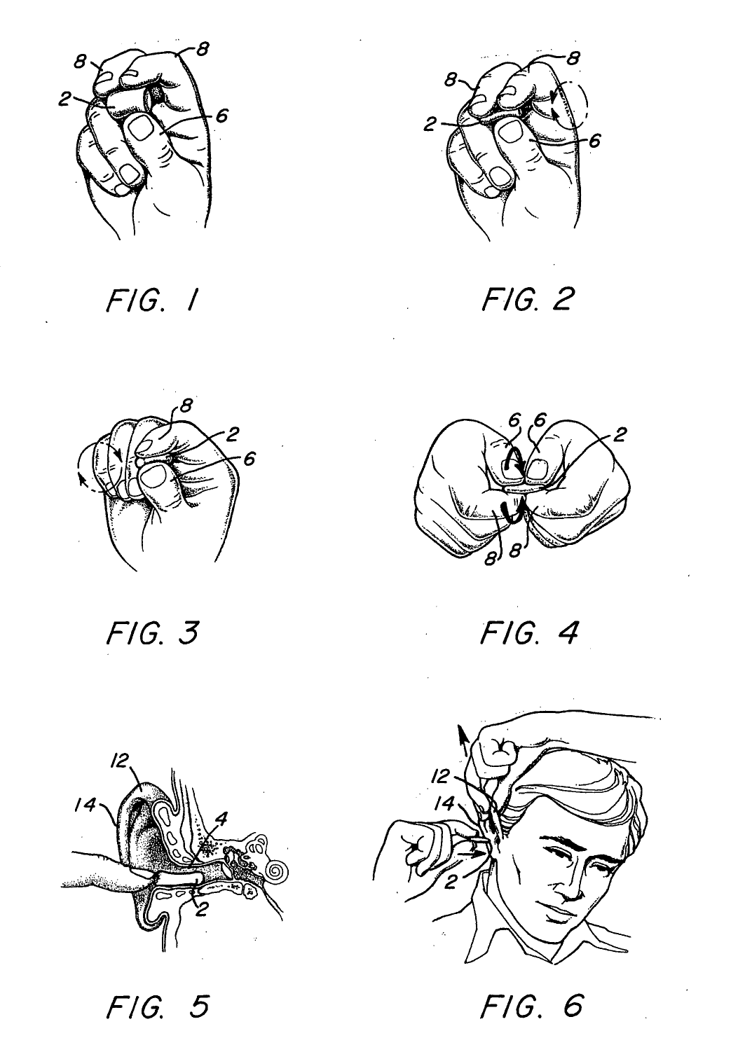

Once the earplugs 34 are extracted, the user turns to the earplug training device 20 of the dispenser 100. The user may then utilize the device 20, as discussed in detail above, to practice preparing the earplug 34 for earcanal insertion or to actually prepare and insert the earplug into the earcanal. Please see above description referring to FIGS. 1-11. Particularly, once the earplug 34 is obtained from the dispenser 100, the user may practice preparing the earplug 34 for earcanal insertion by first rolling down or otherwise compressing the earplug 34 and then attempting to insert the compressed earplug 34 into the first aperture 24. See, FIGS. 7-9 and 12-15. If the earplug 34 is easily received within aperture 24, then it is apparent that at least the preferred compressed diameter D has been achieved. The user may then, in addition to or in the alternative, attempt to insert the compressed earplug 34 into the second aperture 26. If the compressed earplug 34 is readily received within the second aperture 26, then it is apparent that the earplug 34 is compressed even smaller still than the desired diameter D and, thus, the earplug will be even easier to insert properly. The user may then proceed to insert the earplug in the earcanal, if desired, by maintaining the achieved earplug compression and inserting the plug into the canal as described in detail herein.

Where the inset aperture 24, 26 of FIG. 15 is utilized, the resulting dispenser 100 allows the user to practice inserting the earplugs 34 in the apertures 24, 26 to a preferred earcanal insertion depth. That is, the user may roll-down and compress the earplug 34 and then insert the same as far as possible into the apertures 24, 26. The resulting insertion exemplifies the preferred earcanal insertion depth and also indicates to the user an extent of the earplug 34 which is preferably visible when the earplug 34 is seated fully within the inset aperture 24, 26.

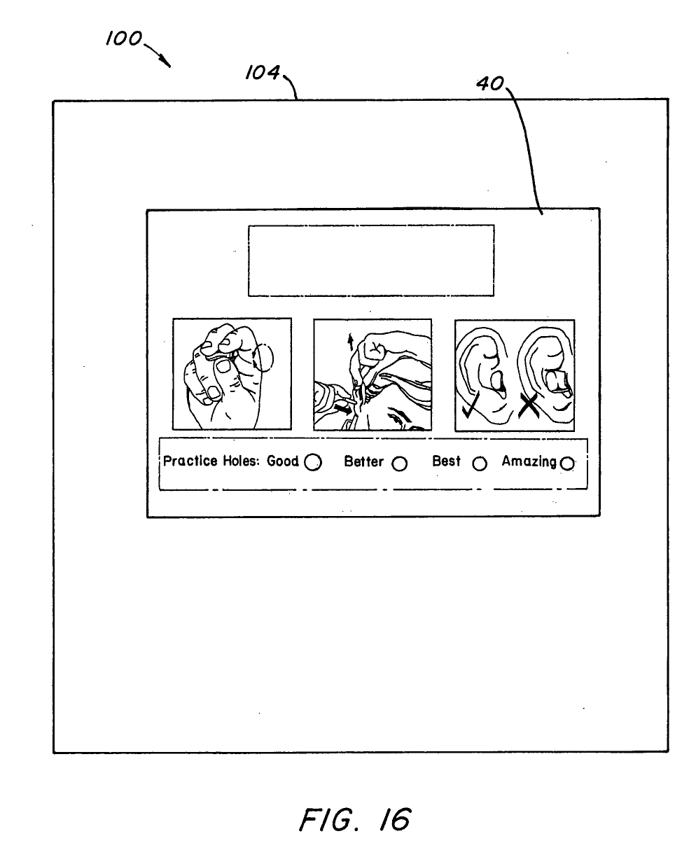

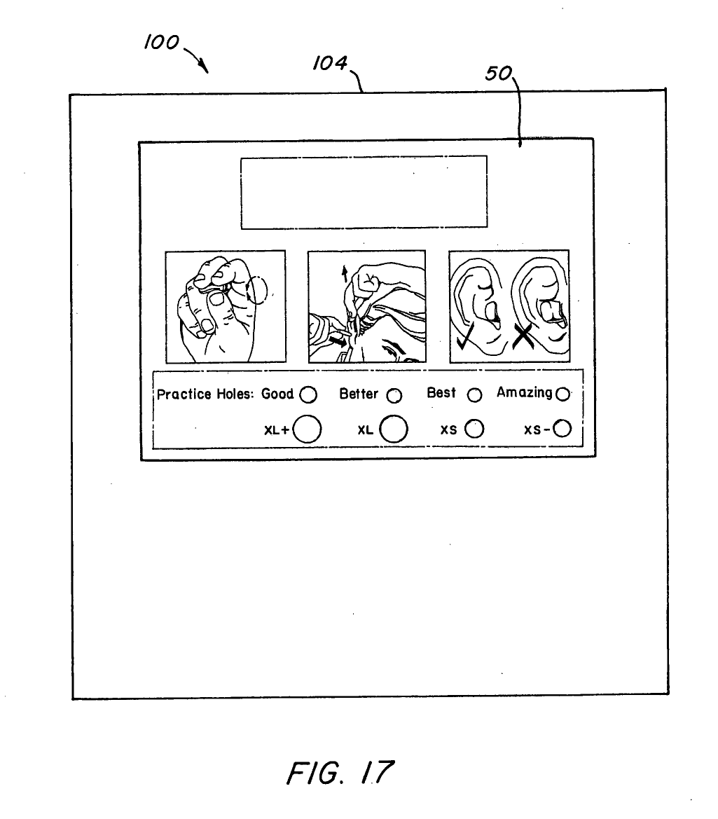

The dispenser 100 is shown herein as including the earplug training device 20 for exemplary purposes only. The dispenser 100 may alternatively include the earplug training devices 40 or 50, as shown in FIGS. 16 and 17, respectively. Such earplug dispenser 100 with device 40, 50 is utilized similar to the dispenser described above with reference to FIG. 12. That is, a user obtains an earplug 34 from the dispenser body 104 and then turns to the device 40, 50 for manually interactive training concerning use of the earplug 34. See description above regarding the devices 40, 50 and use thereof.

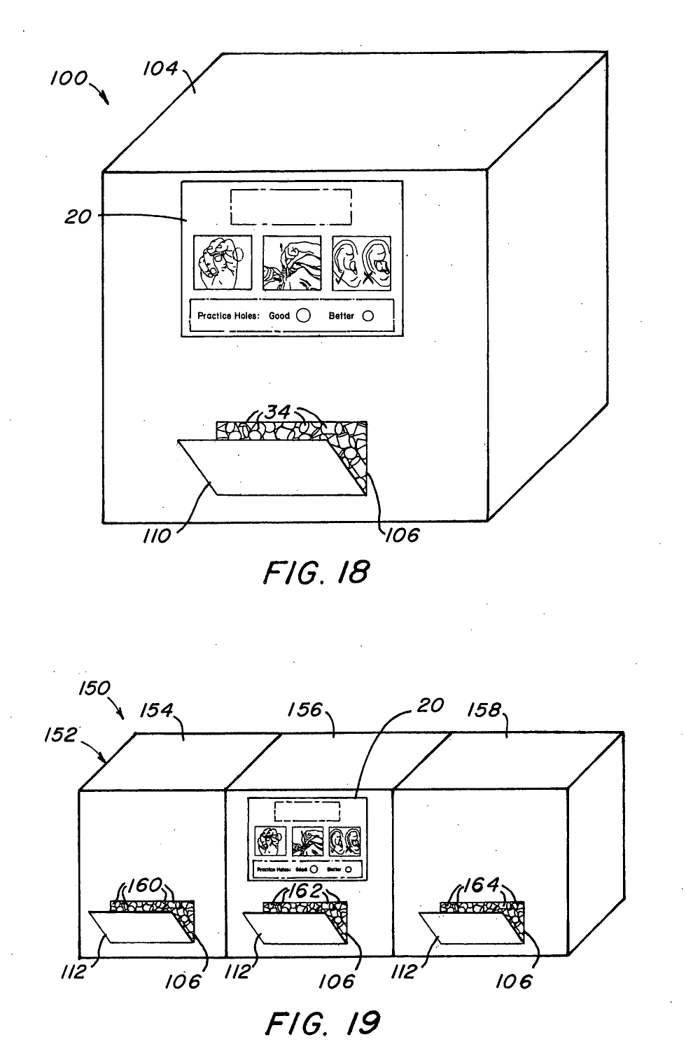

Further, FIG. 18 shows an alternate embodiment of the earplug dispenser 100 having the access portion 106 and the earplug training device 20 disposed on a front panel of the body 104. That is, the training device 20 is disposed on the same side of the body 104 as the access portion 106. Preferably, the training device 20 is disposed proximate the access portion 106 and, for example, just above the access portion 106.

FIG. 19 shows an earplug dispenser 150 according to another embodiment of the invention. Here, the dispenser 150 includes a body 152 which is divided into a plurality of sections 154, 156, and 158 disposed adjacently and fixedly attached to one another. Interiors of the various sections 154, 156, and 158 are distinct, i.e., not in spatial communication. Each interior of distinct section 154, 156, and 158 contains earplugs 160, 162, and 164, respectively. The dispenser 100 includes a plurality of the access portions 106, one corresponding to each section 154, 156, and 158, thus providing direct access to the particular earplugs 160, 162, and 164. Finally, the dispenser 150 includes the training device 20 disposed on the outer surface of the device so as to be readily visible and accessible to the user, for example, the training device 20 is disposed as shown on a front panel of the dispenser 150.

The earplugs 160, 162, and 164 stored within the body 152 of the dispenser 150 are all roll-down foam earplugs but may each be of a distinct type or may vary by size or by any other characteristic as desired. For example, earplugs 160, 162, and 164 may be of serially smaller sizes, or they may be composed of different types or densities of foam, etc.

The earplug dispenser 150 is used to dispense the foam roll-down earplugs 160, 162, and 164 and to provide a tool for training a user concerning use of the dispensed earplugs 34. The earplug dispenser 150 is used similarly to the dispenser 100 described above. That is, a user obtains one of the earplugs 160, 162, or 164 from the various compartments of the dispenser 150 and then utilizes the training device 20 to practice preparing the earplug for insertion or for actually inserting the earplug into the earcanal.

The earplug dispenser 150 may include the aperture 24, 26 of FIG. 14 or 15. Where the aperture 24, 26 of FIG. 15 is utilized, the resulting dispenser 150 includes the additional training and instructional feature concerning insertion depth of the earplug, as explained in detail above.

Of course, the earplug dispenser 150 is shown herein as including the earplug training device 20 for exemplary purposes only. The invention clearly contemplates the dispenser 150 including any of the training devices 20, 40, or 50 or their variations, or any combinations thereof.

Further, while the dispenser 150 is shown with three sections 154, 156, and 158, the invention clearly contemplates the dispenser 150 comprising any number of a plurality of such sections. For example, the dispenser 150 may include two such sections, or four, etc.

The earplug training device 20 has thus far been described herein as being fixed on or integrally formed with the dispensers 100 and 150. However, alternate embodiments of the invention include an earplug dispenser having any of the training devices 20, 40, 50 tethered to the dispensers 100 or 150 by, for example, a cord.

Alternatively, the earplug training device 20, 40, 50 may comprise a card made of paper or cardboard and having a height and width both of several inches. A plurality of such devices 20, 40, 50 may be disposed in a holder on or proximate to the dispenser 100, 150 such that the devices 20, 40, 50, in card form, are distributed to users of the dispenser 100, 150. That is, the user may approach the dispenser 100, 150, obtain an earplug therefrom, and further obtain an earplug training device 20, 40, 50 therefrom, and thus utilize the device in preparing and inserting the earplug in the earcanal.

In another embodiment, a plurality of the devices 20, 40, 50, in card-form as described, may be disposed inside of the dispenser amongst the earplugs. Thus, a user may obtain both an earplug and the training device 20, 40, 50 when accessing the dispenser 100, 150.

The invention provides a device which allows a user to partake in manually interactive, hands-on training and/or practicing concerning use of earplugs, and particularly concerning preferred earplug pre-insertion preparation techniques and actual earcanal insertion techniques. As described above, the device provides an interface at which the user may: practice compressing a roll-down earplug to a preferred insertion diameter; determine whether a chosen earplug is sufficiently sized for a specifically sized earcanal; practice inserting an earplug to a proper insertion depth; prepare an earplug for insertion and then insert the earplug into the earcanal; etc.

As described, in one embodiment, the device comprises a thin, light-weight, portable item which may take the form of a typical business card, a sheet of paper, etc., such that the device may be carried by the user, posted at a work site, etc. In another embodiment, the invention provides the earplug training device disposed at or near an earplug dispenser. Particularly, the device may be incorporated into a side wall of the dispenser, or may be disposed in a holder on the dispenser and distributed to users therefrom, or the device may be disposed inside the dispenser such that a user obtains both an earplug and the device when accessing the dispenser.

Thus, a readily available, effective, and efficient device for training users in preferred use of compressible foam earplugs, and particularly for training users in insertion preparation of foam earplugs, is provided by the invention.

While the invention has been described with reference to an exemplary embodiment, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

1. An earplug training device, comprising:
a thin sheet portion having a front surface and an opposing rear surface; and
a substantially circular hole formed in the thin sheet portion, said hole traversing through the sheet portion from the front surface to the rear surface;
wherein the substantially circular hole enables a user to practice roll down preparation of the earplug.

2. The earplug training device of claim 1, wherein the substantially circular hole includes a diameter less than or equal to a preferred diameter of the earplug for insertion into an earcanal.

3. The earplug training device of claim 2, wherein the diameter of the substantially circular hole is in the range of approximately 0.20 inch to 0.30 inch.

4. The earplug training device of claim 3, wherein the diameter of the substantially circular hole is approximately 0.26 inches.

5. The earplug training device of claim 1, further comprising a second substantially circular hole formed through the thin sheet portion proximate to the first substantially circular hole, wherein the second hole includes a diameter less than the diameter of the first hole, and wherein the diameter of the second hole comprises a more preferred diameter of the earplug for insertion into the earcanal.

6. The earplug training device of claim 5, wherein the diameter of the second substantially circular hole is in the range of approximately 0.18 inches to 0.22 inches.

7. The earplug training device of claim 9, wherein the diameter of the substantially circular hole is approximately 0.20 inches.

8. The earplug training device of claim 5, further comprising:
a plurality of additional substantially circular holes disposed proximate the first and second holes, the additional holes having serially decreasing diameters, the largest of which includes a diameter less than the diameter of the first hole;
wherein the serially decreasing diameters of the additional holes comprise diameters corresponding to serially increasing preferred diameters of the earplug for insertion into the earcanal.

9. The earplug training device of claim 1, wherein the substantially circular hole is one of a first plurality of substantially circular holes of serially decreasing diameters, and wherein the device further comprises a second plurality of substantially circular holes of serially decreasing diameters, wherein the first plurality of holes correspond to preferred diameters of the earplug for facilitating insertion of the earplug into an earcanal and the second plurality of holes correspond to earcanal sizes.

10. The earplug dispenser of claim 1, further comprising a manually interactive portion at which a user may practice preparing the earplug for earcanal insertion, the substantially circular hole being located at the manually interactive portion.

11. The earplug dispenser of claim 10, wherein said practice comprises the user manually compressing the earplug to a reduced diameter and attempting to insert the compressed earplug into the substantially circular hole.

12. The earplug dispenser of claim 10, wherein said manually interactive portion further comprises an interface for determining whether the earplug is suitable for insertion into an earcanal of a particular size.

13. The earplug dispenser of claim 12, wherein said determining comprises the user manually compressing the earplug to a reduced diameter, attempting to insert the compressed earplug into the substantially circular hole, allowing the inserted compressed earplug to decompress in the hole, and checking a fit of the earplug in the hole.

14. An earplug training device, comprising:
a thin sheet portion;
a manually interactive portion disposed on the thin sheet portion;
wherein the manually interactive portion provides a user with hands on instruction and/or training in a use of the earplug comprising at least one of: preparing the earplugs for insertion into an earcanal; inserting the earplugs into the earcanal; checking a sufficiency of a fit of the inserted earplugs; and determining whether the earplugs are suitable for insertion into an earcanal of a particular size.

15. An earplug dispenser, comprising:
a container for storing and dispensing earplugs; and
a substantially circular hole formed in an outer surface of the container; wherein the substantially circular hole enables a user to practice roll down preparation of an earplug.

16. The earplug dispenser of claim 15, wherein the container comprises an access portion formed at the outer surface of the container for allowing dispensing of the earplugs.

17. The earplug dispenser of claim 16, wherein the access portion comprises a hole formed through the outer surface and a door disposed proximate the hole and capable of being placed in an open position, wherein the interior of the container is accessible through the hole, and a closed position, wherein the access to the interior is prohibited.

18. The earplug dispenser of claim 15, further comprising a manually interactive portion disposed at the outer surface of the container for providing the user hands on instruction and/or training in a use of the earplugs, the substantially circular hole being located at the manually interactive portion.

19. The earplug dispenser of claim 15, wherein the substantially circular hole includes a diameter less than or equal to a preferred diameter of the earplugs for insertion into an earcanal.

20. The earplug dispenser of claim 19, wherein the diameter of the substantially circular hole is in the range of approximately 0.20 inch to 0.30 inch.

21. The earplug dispenser of claim 20, wherein the diameter of the substantially circular hole is approximately 0.26 inches.

22. The earplug dispenser of claim 19, further comprising a second substantially circular hole formed in the outer surface of the container proximate to the first hole, wherein the second hole includes a diameter less than the diameter of the first hole, and wherein the diameter of the second hole comprises a more preferred diameter of the earplugs for insertion into the earcanal.

23. The earplug dispenser of claim 22, wherein the diameter of the second substantially circular hole is in the range of approximately 0.18 inches to 0.22 inches.

24. The earplug dispenser of claim 23, wherein the diameter of the substantially circular hole is approximately 0.20 inches.

25. The earplug dispenser of claim 22, further comprising:
a plurality of additional substantially circular holes disposed proximate the first and second holes, the additional plurality of holes having serially decreasing diameters, the largest of which includes a diameter less than the diameter of the first hole;
wherein the serially decreasing diameters of the additional plurality of holes comprise diameters corresponding to serially increasing preferred diameters of the earplugs for insertion into the earcanal.

26. The earplug dispenser of claim 15, wherein the substantially circular hole comprises a cavity set into the outer surface comprising substantially cylindrical walls which extend into an interior of the container and a stop surface disposed transverse to the cylindrical walls closing an end of the cavity.

27. The earplug dispenser of claim 18, wherein the manually interactive portion is disposed at the outer surface and comprises a first plurality of substantially circular holes of serially decreasing diameters and a second plurality of substantially circular holes of serially decreasing diameters, wherein the first plurality of holes correspond to preferred diameters of the earplugs for facilitating insertion of the earplug into an earcanal and the second plurality of holes correspond to earcanal sizes.

28. The earplug dispenser of claim 15, wherein said substantially circular hole comprises an interface at which a user may practice preparing the earplugs for earcanal insertion.

29. The earplug dispenser of claim 28, wherein said practice comprises the user attaining an earplug from the container and manually compressing the earplug to a reduced diameter and attempting to insert the compressed earplug into the substantially circular hole.

30. The earplug dispenser of claim 18, wherein said manually interactive portion comprises an interface for determining whether the earplugs suitable for insertion into an earcanal of a particular size.

31. The earplug dispenser of claim 30, wherein said determining comprises the user manually compressing one of the earplugs to a reduced diameter, attempting to insert the compressed earplug into a second substantially circular hole formed in an outer surface of the container at the manually interactive portion, allowing the inserted compressed earplug to decompress in the hole, and checking a fit of the earplug in the hole.

32. The earplug dispenser of claim 18, wherein the use of the earplugs comprises at least one of: preparing the earplugs for insertion into an earcanal; inserting the earplugs into the earcanal; checking a sufficiency of a fit of the inserted earplugs; and determining whether the earplugs are suitable for insertion into an earcanal of a particular size.

33. The earplug dispenser of claim 15, wherein the container comprises a plurality of separate compartments and a corresponding plurality of access portions for allowing access to interiors of the compartments, and wherein the earplugs comprise a plurality of distinct types of earplugs, each distinct type of earplugs being stored separately in the separate compartments.

34. An earplug dispenser, comprising:
a container for storing and dispensing earplugs;
a manually interactive portion disposed at an outer surface of the container; wherein the manually interactive portion provides a user with hands-on instruction and/or training in a use of the earplugs comprising at least one of: preparing the earplugs for insertion into an earcanal, inserting the earplugs into the earcanal, checking a sufficiency of a fit of the inserted earplugs, and determining whether the earplugs are suitable for insertion into an earcanal of a particular size.

35. The earplug dispenser of claim 34, further comprising an access portion formed in an outer surface of the container for enabling the user to access the earplugs, wherein the manually interactive portion comprises a plurality of holes having serially decreasing diameters formed in the outer surface of the container, a largest of the diameters corresponding to a preferred diameter of the earplugs for facilitating insertion thereof into an earcanal.

36. A method of dispensing earplugs, comprising:
providing the earplugs at an interior of a container;
allowing a user to access the earplugs at the interior; and
providing the user with hands-on instruction and/or training in a use of the earplugs at a manually interactive portion disposed at the container.

37. The method of dispensing earplugs of claim 36, wherein said use of the earplugs comprises at least one of preparing the earplugs for insertion into an earcanal, inserting the earplugs into the earcanal, checking the sufficiency of a fit of the inserted earplugs, and determining whether the earplugs are suitable for insertion into an earcanal of a particular size.

38. The method of dispensing earplugs of claim 36, wherein said providing the user with hands-on instruction and/or training comprises the user practicing preparing one of the earplugs for insertion into an earcanal including manually compressing the earplug and attempting to insert the compressed earplug into a hole formed in an outer surface of the container at the manually interactive portion.
